(19) United States
(12) Patent Application Publication
(10) Pub. No.: US 2008/0190714 A1
(43) Pub. Date: Aug. 14, 2008

(54) Integrated overloaded and braking safety device appropriately applied on the winding mechanism for loading

(76) Inventor: I-Te Pan, Taichung City (TW)

Correspondence Address: I-TE PAN;5F.-2, No. 212, Sec. 1, Wunsin Rd., Taichung City (408), omitted

(21) Appl. No.: 11/724,777

(22) Filed: Mar. 16, 2007

(30) Foreign Application Priority Data
Feb. 9, 2007 (TW) 096202474

(51) Int. Cl. F16D 55/00

(52) U.S. Cl. 188/71.2

(57) ABSTRACT

The present invention relates to an integrated overloaded and braking safety device appropriately applied on the winding mechanism for loading; wherein, brake nut piece equipped with gear wheel of the general mechanical ratchet brake set is redesigned to be separate gear wheel, brake nut piece and gliding spring seat, and by making use of the action of spring force, the abovementioned three components will be combined to be part of the gliding clutch; moreover, via the foregoing improvement, the ratchet brake set and gliding clutch will be integrated as one provided with the function of overloaded-glide and brake. Hence, the effect of safety operation of load-hoisting for the winding mechanism will be acquired.

### BACKGROUND OF THE INVENTION

1) Field of the Invention

The present invention relates to a safety conserve mechanism for mechanical transmission, and especially related to an integrated overloaded and braking safety device appropriately applied on the winding mechanism for loading.

2) Description of the Related Art

General winding machines, e.g. cranes or hoists, are driven by an electric motor and the input power is transmitted by the driving wheel system to hoist the load at the power output terminal, e.g. chain wheel and driving chain fixed at the power output terminal of a crane. Since variable operation conditions will be faced during the hoisting process, many defects will happen, e.g. when a crane hoists the load, sometimes the input power mechanism will be damaged for being overloaded, or sometimes the load will be too heavy and be dropped down on the way of being lifted upward, or the load will be laid down too fast and damage the electric motor for being too heavy. The reason is that the conventional brake and clutch set of the winding mechanism is not integrated effectively and results in the ineffective performance of the proper function of the brake and clutch set. The inventor of the present invention makes use of his experience on manufacturing and marketing the similar products to develop the practical product of the present invention after ceaseless research and test.

### SUMMARY OF THE INVENTION

The major purpose of the present invention is to provide an integrated overloaded and braking safety device appropriately applied on the winding mechanism for loading. The foregoing safety device integrates ratchet brake set and gliding clutch as one provided with the function of overloaded-glide and brake. Hence, the effect of safety operation of load-hoisting for the winding mechanism will be improved substantially.

### BRIEF DESCRIPTION OF THE DRAWINGS

Other features and advantages of the present invention will become apparent in the following detailed description of the preferred embodiments, with reference to the accompanying drawings, in which:

FIG. 1 is a cross-section view of the combination of preferred embodiment of the invention.

FIG. 2 is a plan schematic view of the positive-rotation one-way-glide driving of the ratchet of the invention.

FIG. 3 is a plan schematic view of the reverse-rotation one-way-stop-reverse brake of the ratchet of the invention.

FIG. 4 is a plan schematic view of the driving-wheel's driving upon positive rotation or reverse rotation of the invention.

FIG. 5 is a schematic view of the relative-axle-shift operation upon bolting the nut piece of the brake of the invention.

FIG. 6 is an action schematic view of the operation upon winding the load upward of the invention.

FIG. 7 is an action schematic view of the operation upon hanging the load downward of the invention.

### DETAILED DESCRIPTION OF THE PREFERRED EMBODIMENTS

In the detailed description of the preferred embodiments, it should be noted that like elements are indicated by the same reference numerals throughout the disclosure.

The feature of the mechanism is redesigned the general ratchet brake set to be separate gear wheel, brake nut piece and gliding spring seat, and by making use of the action of spring force, the abovementioned three components will be combined to be part of the gliding clutch; moreover, via the foregoing improvement, the ratchet brake set and gliding clutch will be integrated as one and become an operation system with the safest protecting measures provided with dual joint-action of overloaded-glide and brake.

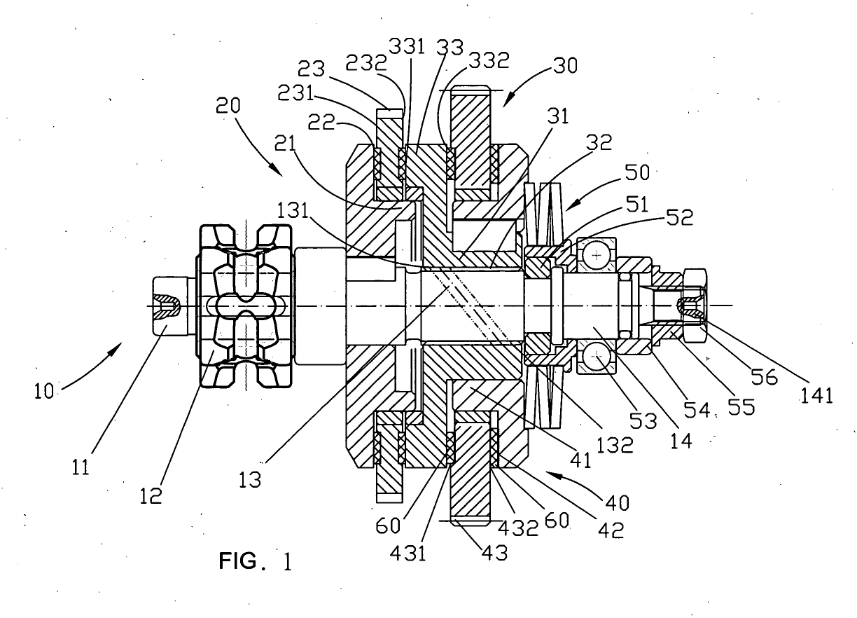

Please refer to FIG. 1; the present invention is an integrated overloaded and braking safety device appropriately applied on the winding mechanism for loading, e.g. a crane or a hoist. It is mainly composed of one transmitting spindle 10, one brake bushing 20, one brake nut piece 30, one spring seat 40 and one elastic component 50.

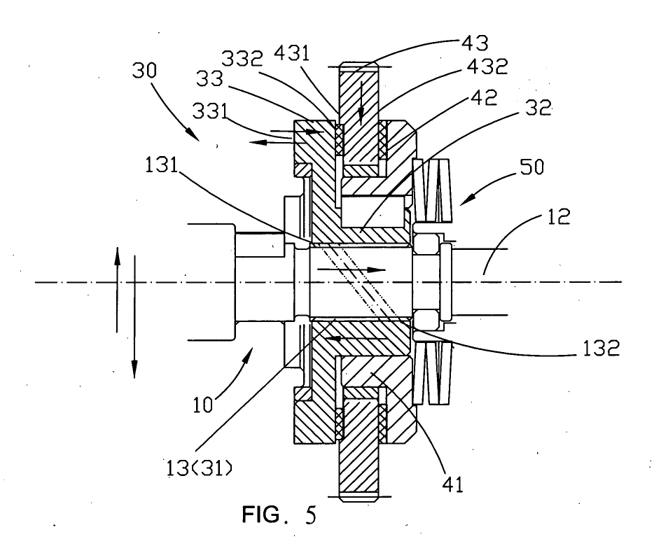

The end on axle direction of said transmitting spindle 10 is set as pivotal connecting part 11 at the pre-fixed caliber. In addition, a transmitting shaft 12 (a chain wheel structure of the preferred embodiment of the present invention) which can be used to output power is fixed on said pivotal connecting part 11; brake bolt thread 13 is concave-downwardly set at the middle section pre-fixed wheelbase outer diameter on axle direction of said transmitting spindle 10, as shown in FIG. 5; moreover, a tightened stopper 131 and a loosened stopper 132 are separately set at the front end and the rear end of the bolt thread terminals. The other pivotal connecting part 14 with pre-fixed caliber is set at the front end on the axle direction, and an outer bolt thread 141 is set at the end of said pivotal connecting part 14.

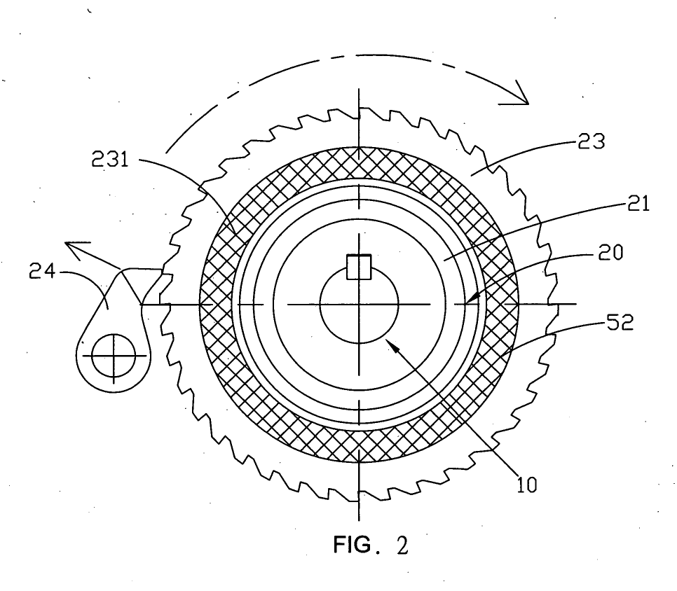

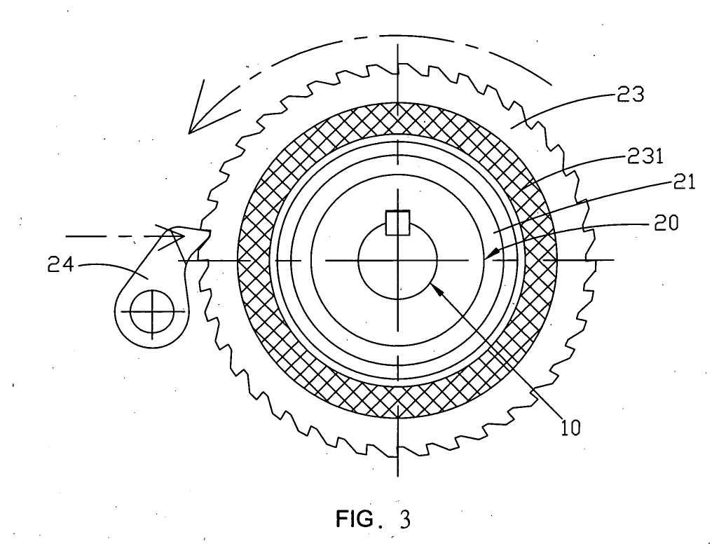

The foregoing brake bushing piece, shown in FIG. 1, is fixed on transmitting spindle 10 at the side of transmitting shaft 12 by the method of coaxial driving; in addition, neck shaft 21 is outwardly set at the side of the end of axle direction on the opposite side of transmitting shaft 12 and resisting-end 22 is formed at the side of vertical end of neck shaft 21. Ratchet 23 is pivotally set on the outer caliber of neck shaft 21 at the condition of one-way driving; restraining-end 231 and 232 are separately set at two ends of the axle direction of ratchet 23. Please refer to FIGS. 2 and 3; one-way pawl 24 is set at the side of teeth of ratchet 23 in response to the spring axle pivot; by making use of the feature that one-way pawl 24 will always maintain one-way occlusion with the teeth side of ratchet 23, idle running of the gliding axle pivot of positive rotation of ratchet 23 (refer to FIG. 2) and stop-reverse brake of reverse rotation of ratchet 23 (refer to FIG. 3) will be maintained.

Brake nut piece 30, shown in FIGS. 1 and 5, has an inner bolting hole 31 by which bolting with brake bolt thread 13 of transmitting spindle 10; moreover, brake nut piece 30 has a hollow neck shaft 32 and a control panel 33 radially extended from hollow neck shaft 32; resisting-end 331 and 332 are separately set at the both ends on axle direction of control panel 33 for tightly packing restraining-end 232 of ratchet 23 by bolting axle shift from both sides.

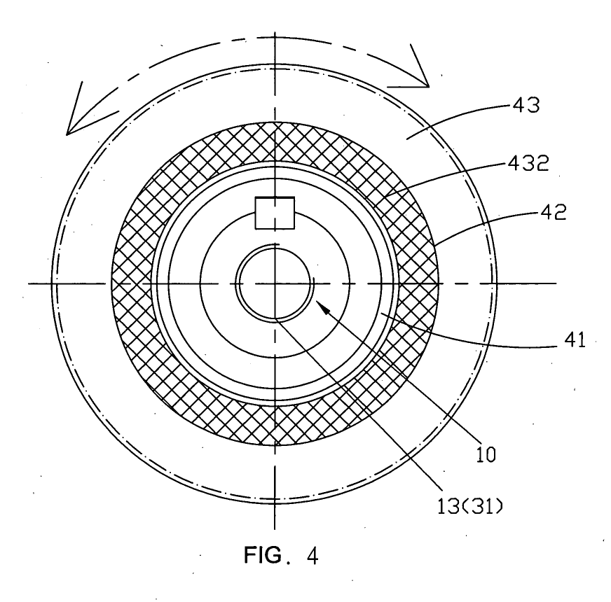

Spring seat 40, shown in FIGS. 1 and 5, is pivotally set on hollow neck shaft 32 of brake nut piece 30 by the method of coaxial driving with transmitting spindle 10; neck shaft 41 is outwardly set at the side of the end of axle direction on the opposite side of brake nut piece 30 and resisting-end 42 is formed at the side of vertical end of neck shaft 41. Driving wheel 43, receiving power source, is pivotally set at the outer caliber of neck shaft 41, shown in FIG. 4; driving wheel 43 is pivotally set with outer caliber of neck shaft 41 and driven by power source to freely turn at positive and reserve two-way operation; restraining-end 431 and 432 are separately set at the two ends of axle direction of driving wheel 43 for tightly packing resisting-end 322 and 42 at both sides of axle direction.

Elastic component 50 is pivotally set at the side of the end of axle direction of spring seat piece 40 by adjusting thrust, shown in FIG. 1; elastic component 50 is a disc-shaped spring and axially positioned in response to received bar 51 and stop bar bushing 52, and the axle direction of elastic component 50 is locked on outer bolt thread 141 of the end of pivot connecting part 14 by one set of bearing 53, bushing 54, an adjusting nut 55 and fixing nut 56 to proceed reciprocal packing operation on the side of sets of brake bushing piece 20, brake nut piece 30 and spring seat piece 40; moreover, adjust default torque by using bolting axle shift adjustment of nut 55 to drive and control the axle direction packing disc-shaped spring of stop bar bushing 52 and bushing 53.

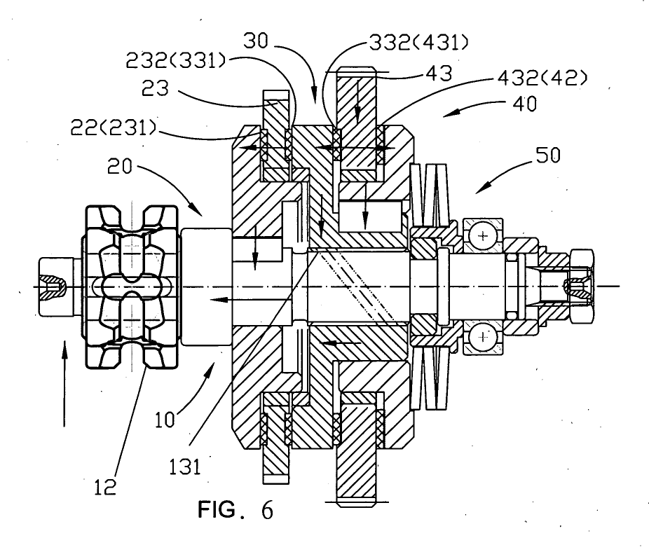

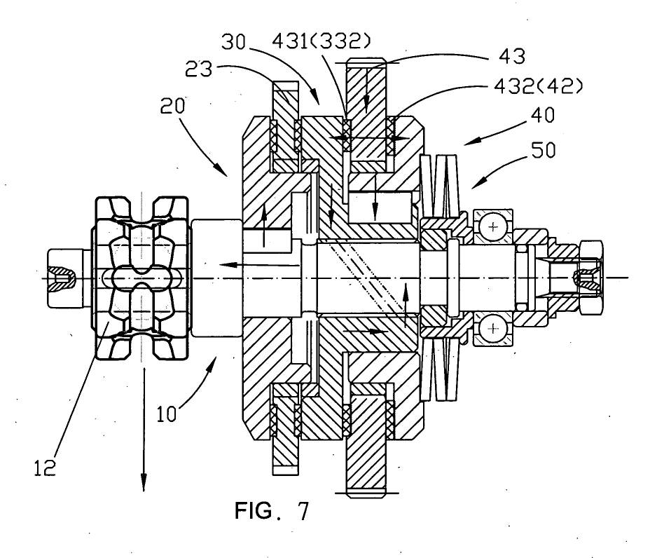

Please refer to FIGS. 6 and 7 for operation of the present invention of an integrated overloaded and braking safety device appropriately applied on the winding mechanism for loading which is composed of abovementioned components.

Need to be explained first is: the present invention makes use of tightly-revolving adjusting nut 55 to increase the strength of elastic component 50; when the friction on the jointing interface between driving wheel 43 and brake nut piece 30, spring seat piece 40 is increased, driving wheel 43 need to transmit stronger torque to proceed glide action; on the contrary, only smaller torque need to be transmitted to proceed glide action; when the load of transmitting wheel 12 at the output end exceeds default torque, driving wheel 43 comparatively glides to protect input transmission from overloading; hence, when the load is not overloaded during transmitting process, the side contiguous to restraining-end 431 and 432 of driving wheel 43 and resisting-end 331 and 332 of brake nut piece 30, and resisting-end 42 of spring seat piece 40 will be packed as one.

Hence, when the present invention hoists the load and proceeds winding operation, under the non-overloaded situation mentioned above, spring seat piece 40 and driving wheel 43 will be packed to synchronously drive brake nut piece 30 to follow its inner bolt hole 31 to proceed bolting axle shift to move from loosely-revolving restraining-end 132 of the front end of the bolt thread to the position of tightly-revolving restraining-end 131 of the rear end of the bolt thread, shown in FIGS. 5 and 6; at the same time of moving toward tightly-revolving restraining-end 131, the side contiguous to resisting-end 331 of brake nut piece 30, restraining-end231 and 232 of ratchet 23 and resisting-end 22 of brake bushing piece 20 will be packed as one, too. At this time, shown in FIG. 2, ratchet 23, one-way driven, will glide synchronously to smoothly winding transmitting wheel 12.

When power source moves to stop from winding action, transmitting spindle 10, brake bushing piece 20, ratchet 23, brake nut piece 30 and spring seat piece 40 will be still controlled by the axle-direction packing of elastic component 50; moreover, one-way driven ratchet 23 will not be able to rotate reversely, shown in FIG. 3, since one-way pawl 24 will clog it; hence, rotation toward the direction of gravity of the load under transmitting spindle 12 will be restrained completely to cause transmitting spindle 10 to be unable to rotate. Therefore, the purpose of restraining rotation will be achieved.

Moreover, when the present invention proceeds the process of lowering the load, if transmitting spindle 12 is not overloaded during lowering transmission process, the side contiguous to restraining-end 431 and 432 of driving wheel 43, resisting-end 331 and 332 of brake nut piece 30 and resisting-end 42 of spring seat piece 40 will be packed as one to receive drive of power source to rotate reversely. At this time will compel synchronously driven brake nut piece 30 to follow its inner bolt hole 31 to proceed bolting axle shift to return from tightly-revolving restraining-end 131 of the rear end of the bolt thread to the position of loosely-revolving restraining-end 132 of the front end of the bolt thread, shown in FIGS. 5 and 7; at the moment of moving toward loosely-revolving restraining-end 132, resisting-end 331 of brake nut piece 30 will be driven to leave from restraining-end231 of ratchet 23 to form the situation of gliding to separate at the jointing interface between brake nut piece 30 and ratchet 23; at the moment, the situation of gliding to separate at the jointing interface between brake bushing piece 20 and ratchet 23 is also formally maintained; moreover, ratchet 23, restrained by one-way pawl 24, keeps unmoved. Transmitting spindle 10 coaxially drives transmitting wheel 12 to lower the load smoothly; the load will be lowered down and dragged by the action of the friction torque during the process; hence, a stable operation speed will be maintained.

If gravity causes the load's lowering down speed faster than driving wheel 43 of power source during the process, please refer to FIG. 5. Because quick-turn-relative-action is proceeded by transmitting spindle 10, at the moment the packed brake nut piece 30 will turn reversely and follow its inner bolt hole 31 to proceed bolting axle shift to return from loosely-revolving restraining-end 132 of the front end of the bolt thread to the position of tightly-revolving restraining-end 131 of the rear end of the bolt thread; at the second of twinkling an eye, brake nut piece 30 will proceed axle shift again to pack ratchet 23 for restraining it to stop.

What's more, for increasing the friction-stopping effect of the interfaces, brake lining 60 will be fixed at the jointing interface of foregoing resisting-end 22, restraining-end 231 and 232 of brake bushing piece 20, resisting-end 331 and 332 of brake nut piece 30, restraining-end 431 and 432 of spring seat piece, restraining-end 231 and 232 of ratchet 23, and restraining-end 431 and 432 of driving wheel 43.

1. (canceled)

2. (canceled)

3. (canceled)

4. (canceled)

5. An integrated overloaded and braking safety device appropriately applied on the winding mechanism for loading, comprising:
a transmitting spindle and a transmitting wheel co-axially fixed at one end of the transmitting spindle for being used to output power, a brake bolt thread set at an outer periphery of a middle section of the transmitting spindle, a tightened stopper and a loosened stopper separately and respectively formed on a front terminal end and a rear terminal end of the brake bolt thread, a pivotal connecting part with a certain caliber from at the front end of the transmitting spindle and having an outer bolt thread form on the pivotal connecting part;
a bushing piece fixed on the transmitting spindle for being coaxial driven, a neck shaft outwardly extending from the bushing piece opposite to the transmitting wheel and a restraining-end from on a vertical side of the neck shaft, a ratchet pivotally sleeved on the neck shaft, the ratchet having two opposite sides each having a restraining-end formed thereon;
a brake-nut piece having a threaded hole by which screwed onto the brake bolt thread of the transmitting spindle, the brake nut piece having a hollow neck shaft formed thereon and a control panel radially extending from the hollow neck shaft, the control panel having two opposite sides each having a resisting-end formed thereon for tightly packing the restraining-end of the ratchet;
a spring seat pivotally sleeved on the hollow neck shaft of the brake nut piece for coaxially driven with the transmitting spindle, the spring seat axially corresponding to the brake nut piece and having a shaft outwardly extending therefrom, the shaft resisting end formed on a vertical end of the shaft, a driving wheel pivotally sleeved on the shaft and adapted to be connected to a power source, the driving wheel pivotally set with the outer caliber of the shaft and driven by the power source of input terminal to freely turn at positive and reserve two-way operation, the driving wheel including two opposite sides each having a restraining-end formed thereon for tightly and axially packing the resisting-ends of the control panel and the shaft; and
an elastic component pivotally and axially mounted to the spring seat by adjusting thrust to proceed reciprocal packing operation on the side of sets of the bushing piece, the brake nut piece and the spring seat;
whereby a gliding clutch function with a default load can be structured at one side of the axle of the brake nut piece, spring seat and the elastic component, and the bushing piece and the one-way driving ratchet to form a mechanical brake function, when the load of the transmitting wheel is over defaulted torque, the driving wheel proceeding relative glide to protect an input transmission from being overload, under the non-overloaded situation, the spring seat , the driving wheel, the brake nut piece and the bushing piece reciprocally packed as and one-piece element, the ratchet synchronously gliding to smoothly proceed the winding operation of the transmitting wheel, when the power source moved from winding action to stop, the transmitting spindle, at first, rotating reversely because of the load; but restrained soon because of the one-way restraining action proceeded by the packing ratchet, when transmitting wheel moved downward, the brake nut piece proceeding axle shift to move backward to loosen the packing pressure pressed on the ratchet for decreasing thrust, when the gravity causes the load's lowering down speed faster than that of the driving wheel of the power source, because of the transmitting spindle's quick-turn-relative-action, the brake nut piece proceeding axle shift again to move forward to pack the ratchet for restraining it to stop, hence, the safety effect of the operation of winding mechanism's hoisting the load be increased substantially.

6. The integrated overloaded and braking safety device as claimed in claim 5, wherein a one-way pawl is disposed at a teethed side of the ratchet in response to a spring axle pivot, whereby the one-way pawl will always keep a one-way occlusion with the teethed side of the ratchet such that the idle running of the ratchet's positive rotation and the restraining stop for reverse rotation will be maintained.

7. The integrated overloaded and braking safety device as claimed in claim 5, wherein the elastic component is a disc-shaped spring and axially positioned in response to a received bar and a stop bar bushing, and the axle direction of the elastic component is locked on an outer bolt thread of the end of the pivot connecting part by one set of a bearing, a bushing, an adjusting nut and a fixing nut.

8. The integrated overloaded and braking safety device as claimed in claim 5, wherein at least one brake lining is fixed on an interfaces of each of the corresponding resisting-end and the restraining-end to increase a brake effect of the interfaces.
